(19) United States
(12) Patent Application Publication
(10) Pub. No.: US 2012/0047044 A1
(43) Pub. Date: Feb. 23, 2012

(54) Method to Develop Search Engine Optimized Content Through a Web-Based Software Platform

(76) Inventor: Stephen James Lazuka, Chardon, OH (US)

(21) Appl. No.: 13/214,018

(22) Filed: Aug. 19, 2011

Related U.S. Application Data
(60) Provisional application No. 61/375,078, filed on Aug. 19, 2010.

(51) Int. Cl. G06Q 30/00

(52) U.S. Cl. 705/26.4

(57) ABSTRACT

The present invention is a web-based software platform used to implement a method for purchasing the highest quality content possible, for the lowest possible market driven prices, from the most qualified profession writer possible. Writers are able to setup an account and log on to the present invention in order to take on projects to develop content for a client or a marketing agency. Thus, the present invention allows for a marketplace of writers. Both an individual client and a marketing agency can setup an account and log on to the present invention in order to post projects. Individual clients post projects for content that they need to be written, while marketing agencies post projects for content that their clients need to be written. Marketing agencies are able to manage multiple projects for multiple clients on the present invention. Individual clients and marketing agencies are also able to set a price on how much they are willing to pay the writer to produce the content.

The current application claims a priority to the U.S. Provisional Patent application Ser. No. 61/375,078 filed on Aug. 19, 2010.

### FIELD OF THE INVENTION

The present invention relates generally to a software platform that allows users to develop search engine optimized content using a marketplace of qualified writers

### BACKGROUND OF THE INVENTION

Traditional Search Engine Optimization processes involve improving the visibility of a website in search engine results. However, they do not provide a marketplace of writers that can help develop content that is search engine optimized, nor do they provide a technology platform that organizes all the necessary steps and makes it simple for the average user that is not an expert in SEO or content development. The present invention provides its users a simple yet sophisticated system that allows them to get high quality, search engine optimized content from a large pool of pre-screened writers, all for prices that are far below typical content costs.

### BRIEF DESCRIPTION OF THE DRAWINGS

FIG. 1 is simplified flow chart illustrating what the present invention does from the single client's perspective.

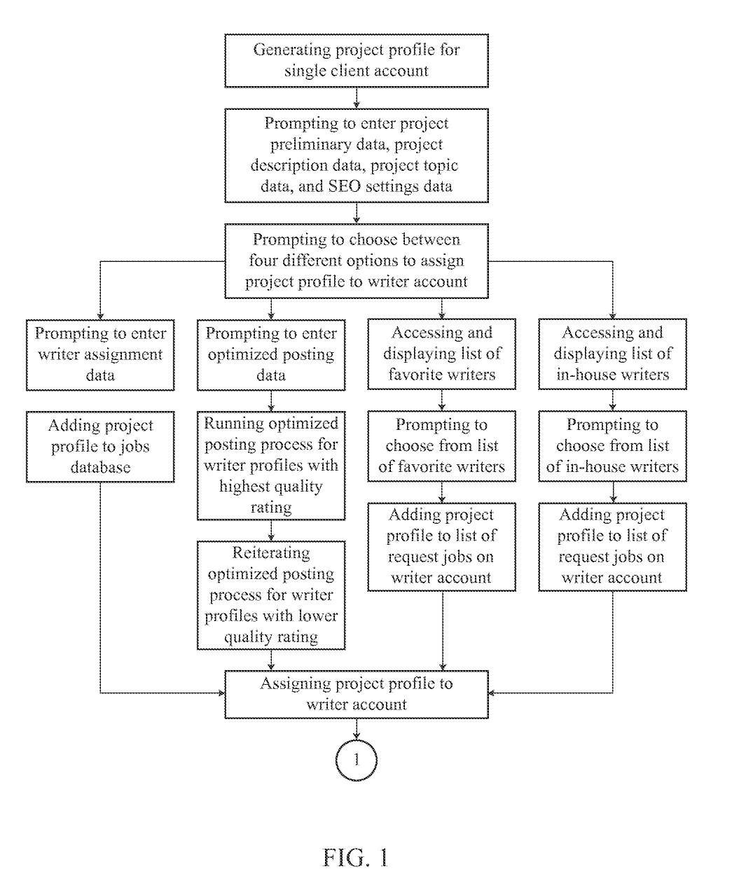

FIG. 2 is continuation of the flow chart shown in FIG. 1.

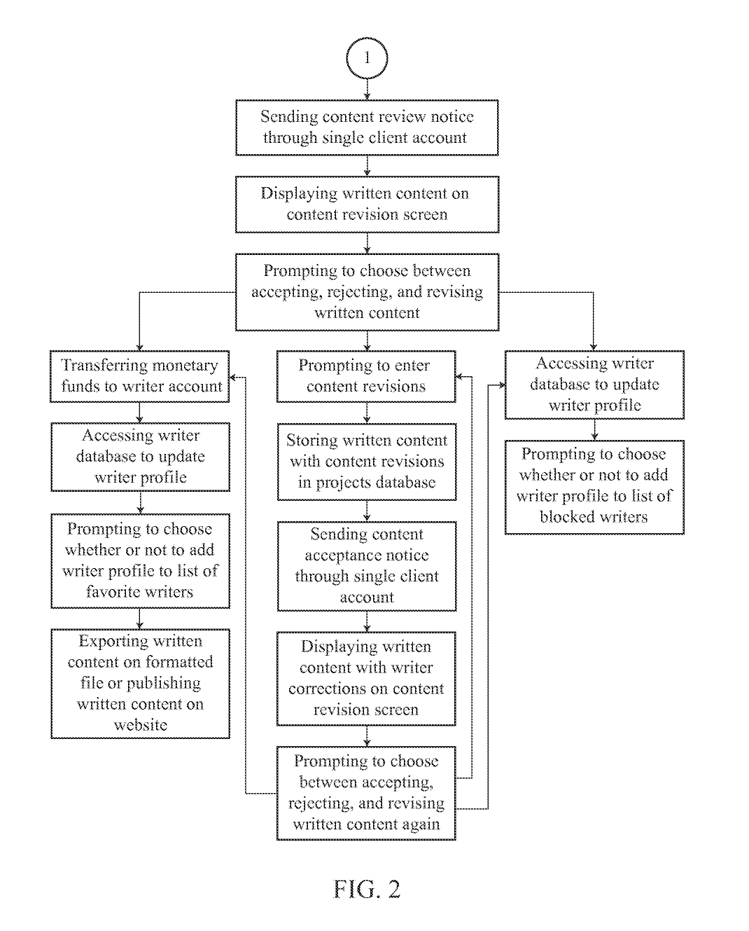

FIG. 3 is simplified flow chart illustrating what the present invention does from the writer's perspective.

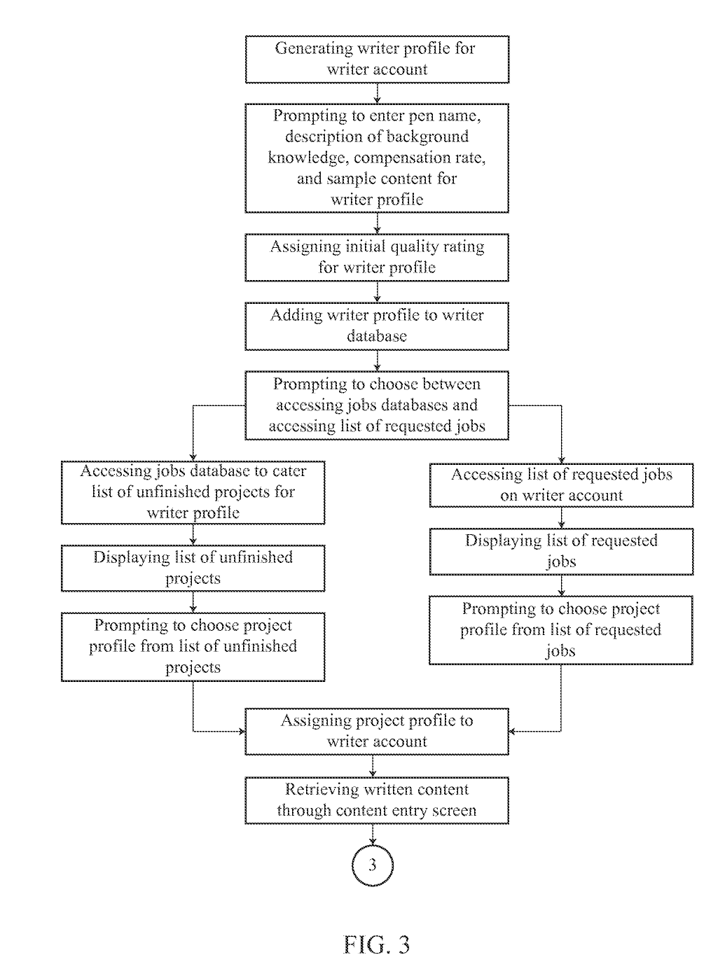

FIG. 4 is continuation of the flow chart shown in FIG. 3.

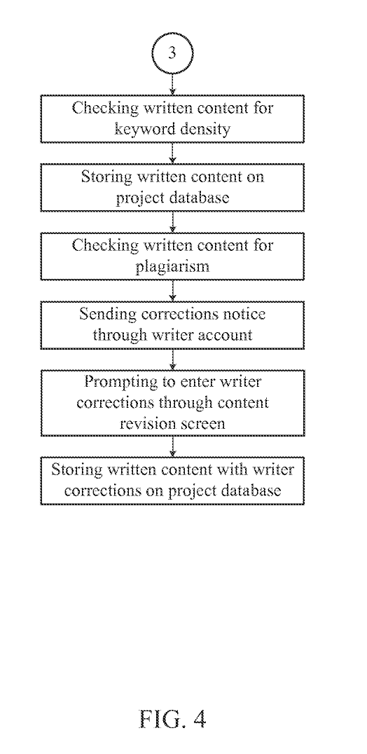

FIG. 5 is simplified flow chart illustrating what the present invention does from the marketing agency's perspective.

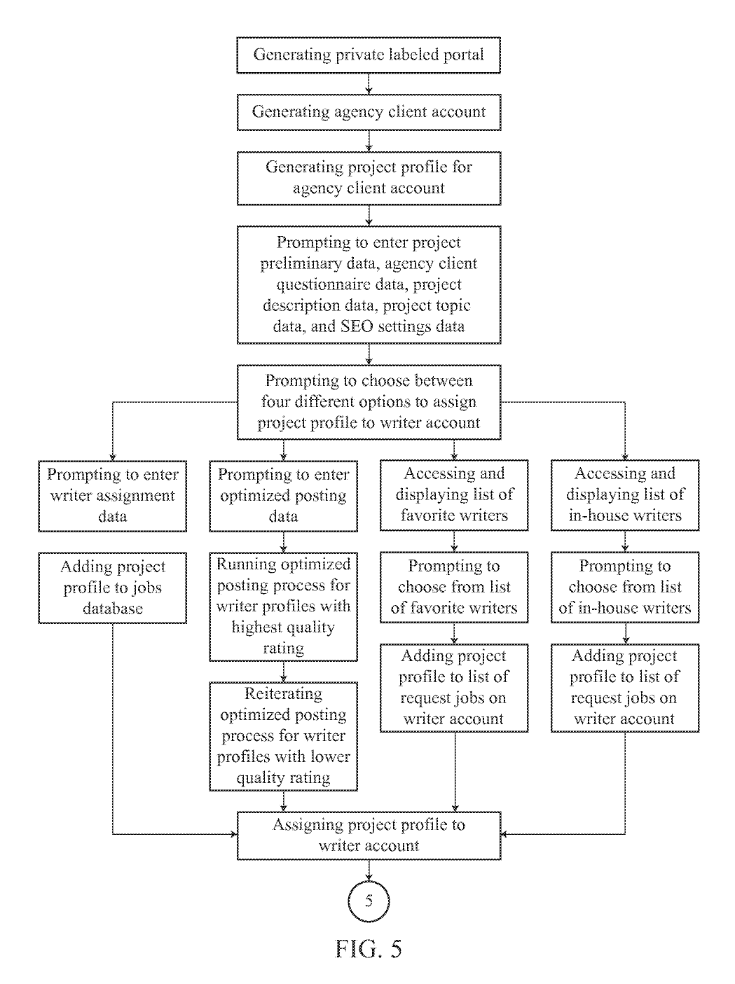

FIG. 6 is continuation of the flow chart shown in FIG. 5.

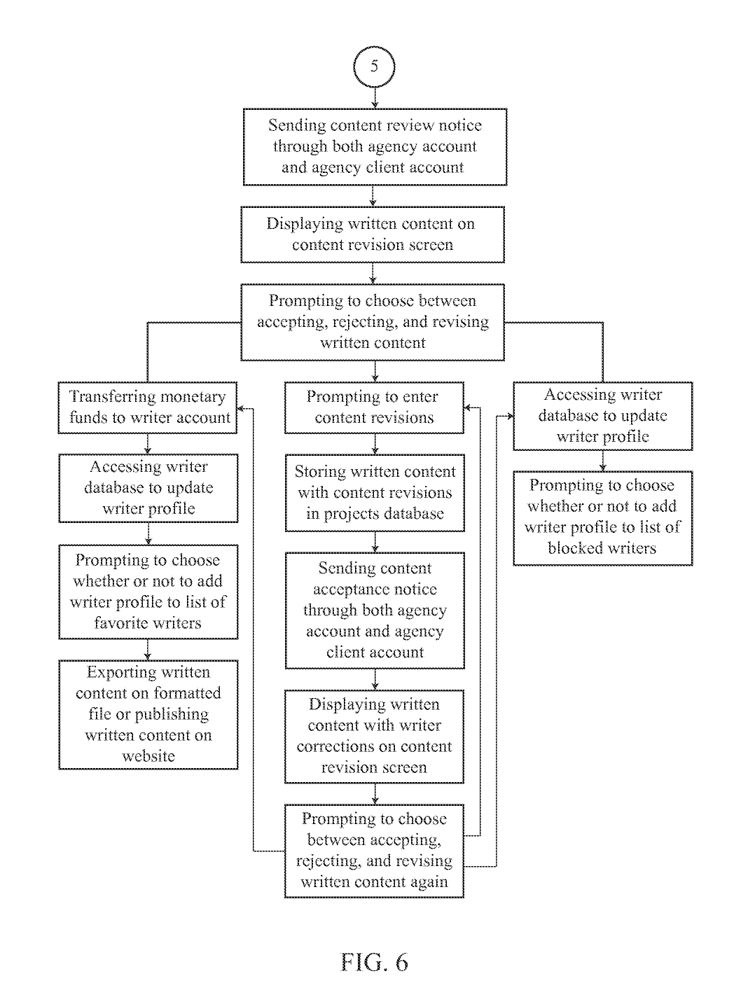

### DETAIL DESCRIPTIONS OF THE INVENTION

All illustrations of the drawings are for the purpose of describing selected versions of the present invention and are not intended to limit the scope of the present invention.

The present invention is a web-based software platform used to supply written content to a single client by posting the task to a marketplace of writers. The written content could be produced for any online or print media, but the present invention is primarily structured to develop search engine optimized (SEO) content, which is content written for a website to increase the website's visibility on search engines. A single client is an entity that uses the present invention to develop written content for them. A writer uses the present invention to find clients that need to have written content produced for them. The web-based software platform allows the single client and the writer to communicate with each other and to manage a project, where the project consists of developing the written content.

In order to use the present invention, the writer must setup a writer account to access the web-based software platform. The writer account contains only a list of requested jobs, which are direct inquiries from single clients to produce their written content. The writer account can also be used to setup a writer profile. The writer profile provides the single client with pertinent information about the writer. The writer profile consists of a pen name, a sample content, a quality rating, a description of background knowledge, a rejection rate, a compensation rate, and a written content history. When the writer creates a writer profile, the present invention prompts the writer to enter the pen name, the sample content, the description of background knowledge, and the compensation rate. The pen name is an alias used by the writer to hide the writer's real name from the single client for security purposes. The sample content depicts the writer's ability to produce quality written content and is used to determine the writer's initial quality rating, which quantifies the writer's ability to produce quality written content. The description of background knowledge is a collection of topics that the writer can adequately articulate into the written content. The compensation rate is the amount of money that the writer wants to be paid per word, per paragraph, or per page for producing the written content. The writer profile is stored on a writer database, which stores the writer profile of every writer that activates a writer account on the present invention. The writer database allows the present invention to update the writer profile as the writer completes different projects. The rejection rate is updated as the present invention records the ratio between the total number of times that the writer's written content has been rejected and the total number of times the writer has produced written content. The quality rating is also updated as the present invention allows the single client to assess the quality rating of the written content produced by the writer. Finally, the written content history is updated as the present invention records what topic the writer wrote about in the written content and who wanted the written content to be produced. The writer database creates a marketplace of writers on the present invention, where different single clients are able to compare and contrast the characteristics of different writer profiles such as compensation rate versus quality rating.

In order to use the present invention, the single client must setup a single client account to access the web-based software platform. The single client account contains a monetary fund, a list of favorite writers, a list of blocked writers, and a list of in-house writers. The monetary fund attached to the single client account allows the single client to pay the writer once the project has been completed. The list of favorite writers allows the single client to keep track of the writers that produced acceptable written content for the single client. The list of blocked writers allows the single client to keep track of the writers that produced unacceptable written content for the single client. The list of in-house writers allows the single client to keep track of the writers that have not registered with the present invention and that the single client uses to outsource a project. The present invention requires the single client to setup a writer account for an in-house writer but does not require the single client to create a writer profile because an in-house writer will only be producing written content for that single client.

The single client account allows the single client to setup a project profile, which delineates the guidelines of the project for the present invention. The project profile consists of project preliminary data, project description data, project topic data, project title data, SEO settings data, optimized posting data, and writer assignment data. When the single client creates a project profile, the present invention displays a screen to prompt the single client to enter the project preliminary data. The project preliminary data includes a project name and a content type. The project name is a name designated by the single client to identify the project profile, which is important because the single client account can store multiple project profiles. The content type is the kind of media that the written content will be posted on such as an article, a blog post, or an e-book. Second, the present invention displays a screen to prompt the single client to enter the project description data, which includes a word count range, a writing style, a narrative, additional options, and additional writing instructions. The word count range describes the number of words that should be put into the written content. The writing style is the overall tone that the written content should be written in. For example, the written content could be written in a conversational tone, a professional tone, an informal tone, or a witty tone. The narrative describes whether the written content should be written in first person, second person, third person, or a completely different point of view. The additional options describes the formatting of the written content such as how the written content should be sectioned and whether the writing content should include bulleted lists. The additional writing instructions are comments written by the single client to further instruct the writer on how the written content should be produced. Third, the present invention displays a screen to prompt the single client to enter the project topic data, which consists of a plurality of keywords. The single client chooses the plurality of keywords to be inserted into the written content by the writer, which will increase the written content's visibility on search engines. The single client also chooses a keyword priority rank for each of the plurality of keywords, which ranks the importance of a keyword in relation to the overall topic of the written content. Fourth, the present invention displays a screen to prompt the single client to enter the project title data, which consist of a plurality of titles. The web-based software platform allows the single client to input their own personal titles for the written content into the screen or generates the plurality of titles from the plurality of keywords entered on the previous screen. The single client chooses a title priority rank for each of the plurality of titles, which allows the single client to convey to the writer which of the plurality of titles is better for the written content. Finally, the present invention displays a screen to prompt the single client to enter the SEO settings data, which includes the keyword density. The keyword density is the number of times a keyword should appear in the written content. In the preferred embodiment of the present invention, the screen prompting to enter the SEO settings data allows the single client to choose between the four different keyword densities: any number of appearances, an appearance every two or three paragraphs, an appearance every paragraph, and more than one appearance every paragraph.

The web-based software platform allows the single client to complete the project profile by choosing one of four different options to find a writer that will take on the project. The first option is to allow the web-based software platform to present the project profile to all of the writers with a writer profile on the writer database. To begin the first option, the present invention prompts the single client to enter the writer assignment data and, thus, completes the project profile. The writer assignment data consists of a required background knowledge, a minimum quality rating, a maximum rejection rate, and a maximum compensation rate. The required background knowledge is the topics that a writer must understand and have a firm grasp on to properly produce the written content. The minimum quality rating, the maximum rejection rate, and the maximum compensation rate are cutoffs describing the caliber of writer that the single client covets to produce their written content. The first option is continued by adding the project profile to the jobs database, which allows the present invention to store every project profile of every single client with a single client account. The present invention allows every writer with a writer account to search through the jobs database, which provides a list of unfinished jobs catered to match the writer profile of each writer. The first option is completed the present invention is assigned the project profile to the writer account. For the present invention, the project profile can only be assigned to the writer account when the writer decides to take on the project and produce the written content. The second option is to allow the present invention to help the single client find a writer profile with the highest possible quality rating at the lowest possible compensation rate. To begin the second option, the present invention prompts the single client to enter the optimized posting data and, thus, completes the project profile. The optimized posting data consists of a maximum price offer, which is the highest amount of money that the single client is willing to pay per word, per paragraph, or per page to have their written content produced. The present invention proceeds with the second option by implementing an optimized posting process for the writers with the highest quality rating. The optimized posting process adds the project profile to the jobs database and makes the project profile available to writers at the lowest possible price offer for a set amount of time. If the project profile is not assigned to a writer account at the end of the set amount of time, then the optimized posting process increases the price offer of the project profile and, again, makes the project profile available on the jobs database for the set amount of time. The optimized posting process continually increases the price of the project profile after every set amount of time that the project profile is not assigned to a writer account, until the price offer is equal to the maximum price offer specified by the single client. The optimized posting process is repeated until the project profile is assigned to a writer account. Each time that the optimized posting process is repeated, the present invention makes the project profile available to writers with a lower quality rating. Thus, the present invention is able assign the project profile to a writer account with the highest possible quality rating at the lowest possible price offer.

For the other two options, the project profile is already considered to be complete by the present invention because no other information is required to assign the project profile to a writer account. The third option begins by accessing the list of favorite writers from the single client account, displaying the list of favorite writers to the single client, and prompting the single client to choose one of the writers shown on the list of favorite writers. Once the single client has chosen a writer, the project profile is added to the list of requested jobs of that writer account. If the writer chooses to take on the project, then the present invention will assign the project profile to the writer account. Similarly, the fourth option begins by accessing the list of in-house writers from the single client account, displaying the list of in-house writers to the single client, and prompting the single client to choose one the writers shown on the list of in-house writers. Once the single client has chosen an in-house writer, the project profile is added to the list of requested jobs of that writer account. If the writer chooses to take on the project, then the present invention will assign the project profile to the writer account.

The present invention also allows the single client to reuse the project profile for a new project. The data associated with the project profile of the original project can be altered to match the details of the new project, otherwise the present invention will use the data associated with the project profile of the original project to develop the written content of the new project. For example, if the project profile of the original project uses either the third option or the fourth option to designate a writer to the project profile, then all new projects using the project profile will use the same designated writer, until the single client alters project profile to find a different writer.

In order to assign the project profile to the writer account, the writer must choose to take on the project. The writer can choose to take on a project by one of two ways on the present invention. One way is to use the present invention to access the jobs database and generate a list of unfinished projects that is catered to the writer profile. The present invention then allows the writer to view the project profile of each of the projects on the list of unfinished projects and allows the writer to choose which of the projects on the list of unfinished projects to accept. The other way is use the present invention to access the list of requested jobs on the writer account and display list of requested jobs to the writer. Likewise, the present invention then allows the writer to view the project profile of each of the projects on the list of requested jobs and allows the writer to choose which of the projects on the list of requested jobs to accept.

Once the writer accepts the project, the present invention utilizes a content entry screen, which allows the writer enter the written content for that project. The content entry screen is designed to resemble and function much like a typical word processor. As the writer enters the written content into the content entry screen, the present invention checks and notifies the writer if the keyword density of the written content does not match the keyword density defined by the single client in the project profile. After the writer completes the written content on the content entry screen, the present invention adds the written content to a projects database. The projects database stores the written content of every project profile and allows both the single client and writer to access the written content. However, before the single client can review the written content, the present invention searches the entire internet database to check if written content has somehow been plagiarized. If the present invention suspects the written content to be plagiarized, then the present invention will notify the writer and instruct the writer to change the written content. If the present invention does not suspect the written content to be plagiarized, then the present invention will send a content review notice to the single client through the single client account.

Once the single client receives the content review notice through their single client account, the present invention displays the written content on a content revision screen. The content revision screen allows the single client or the writer to edit the written content and add comments, which are stored with the written content on the projects database. After the written content is shown to the single client, the present invention prompts the single client to choose between accepting the written content produced by the writer without any revisions, rejecting the written content produced by the writer without any revisions, or entering a revision process with the writer. If the single client accepts the written content produced by the writer, then the present invention transfers the monetary funds owed by the single client from the single client account to the writer account. The amount of monetary funds transferred to the writer account depends on the maximum compensation rate defined by the single client in the project profile and the number of words, paragraphs, or pages that the writer wrote in the written content. When the monetary funds are transferred to the writer account, the present invention will prompt the single client to choose which formatted file to output the written content. Some formatted files include .txt, .doc, .html, XML, and RSS. The present invention will then output the written content as the formatted file selected by the single client. The present invention also allows the single client to export the written content to a variety of third party content management systems and websites. Finally, the present invention will also allow the single client to add the writer profile to the list of favorite writers on the single client account and to assess a quality rating for the completed written content. If the single client rejects the written content produced by the writer, the present invention does not transfer any monetary funds from the single client account to the writer account. The present invention will also allow the single client to add the writer profile to the list of blocked writers on the single client account.

If the single client deems the written content to be acceptable with revisions, then the present invention allows the single client to make content revisions on the content revision screen. The content revisions includes edits to the text and notes to the writer, where the edits to the text suggest small changes to the wording of the written content and notes to the writer suggest more significant changes to the written content. After the content revisions are stored with the written content in the projects database, the present invention sends a corrections notice to the writer through the writer account. The present invention displays the written content to the writer through the content review screen with the content revisions so that the writer can view and understand the content revisions and enter writer corrections into the content revision screen. The writer corrections include reedits to the text and notes to the client. Reedits to the text suggest the changes that can be made to the written content without diverging from the context of the written content, and notes to client suggest why certain changes in the written content can or cannot be tolerated. After the writer corrections are stored with the written content in the projects database, the present invention sends a content acceptance notice to the single client through the single client account. The content acceptance notice informs the single client that the written content has been revised by the writer. At the end of revision process, the present invention again prompts the single client to choose between accepting the written content produced by the writer without any more revisions, rejecting the written content produced by the writer without any more revisions, or entering another revision process with the writer. The revision process is repeated by the present invention, until the written content is accepted or rejected by the single client.

The present invention can also be structured to accommodate the content needs of a marketing agency. A marketing agency is an entity that uses the present invention to develop written content for clients of the marketing agency, which means a marketing agency usually has multiple projects that need to be completed. The present invention allows the marketing agency to manage multiple projects for multiple “agency clients” (clients of the marketing agency) and find writers to complete each agency client's projects. In order to use the present invention, the marketing agency must setup an agency account to access the web-based software platform. Similar to the single client account, the agency account consists of a monetary fund, a list of favorite writers, a list of blocked writers, and a list of in-house writers. The monetary fund, the list of favorite writers, the list of blocked writers, and the list of in-house writers serve the same purposes for the agency account as they do for the single client account. The agency account also consists of a list of agency clients, which allows the marketing agency to record which of their clients have an agency client account. The agency client account must be setup by the marketing agency for an agency client and allows the agency client to access the present invention. When the marketing agency creates an agency client account, the present invention displays a screen to prompt the marketing agency to enter agency client personal data and agency client contact data. The agency client personal data is basic information to identify the agency client such as the agency client's first and last name. The agency client contact data is contact information to communicate with the agency client such as the agency client's email and phone number. Once the marketing agency enters the agency client personal data and the agency client contact data into the present invention, the agency client account is complete and can be added to the list of agency clients.

The agency account allows the marketing agency to setup a private labeled portal, which allows the agency client to access certain features of the present invention that are pre-chosen by the marketing agency. When the marketing agency creates a private labeled portal, the present invention displays a screen to prompt the marketing agency to enter branding data, agency client access data, a user access data, and an agency contact data. The branding data is an image of the marketing agency's logo and allows the present invention to display the marketing agency's logo on the private labeled portal. The agency client access data describes which features of the present invention that the agency client is able to access through the agency client account with the private labeled portal. For example, the agency client access data would allow the marketing agency to dictate whether or not an agency client would be able to fill out an agency client questionnaire or to dictate whether or not an agency client would be able to make content revisions during the revision process. The user access data describes which additional users can log on to the agency account in order to make changes to the private labeled portal. The agency contact data describes which kinds of contact information for the marketing agency are available to the agency client. Once the private labeled portal is complete, an agency client is able to access the private labeled portal through their agency client account and can only use the features specified by the marketing agency.

The agency account is designed with the intent to purchase written content for each of the agency's clients at a low price from the marketplace of writers and to sell the written content to each of the agency's clients at higher price outside of the present invention. Thus, the present invention allows the marketing agency to go through virtually the same process of producing written content as a single client, which includes creating a project profile, assigning the project profile to a writer, revising the written content produced by the writer, and either accepting or rejecting the written content by the writer. One significant difference is that the project profile also consists of agency client questionnaire data. Thus, when the marketing agency is creating a project profile, the present invention will additionally prompt the marketing agency to enter agency client questionnaire data. The agency client questionnaire data is the answers to questions asked by the marketing agency to the agency client to better understand the kind of written content that the agency client wants to be produced. The present invention provides the marketing agency either with a standard questionnaire, which uses a set of pre-populated questions, or allows the marketing agency to creates a new custom questionnaire by using a custom form builder. The custom form builder allows the marketing agency to create multiple types of questions including drop downs, text fields, and multiple choice fields. The agency client questionnaire data can be entered either through the agency account by the marketing agency or through the agency client account with the private labeled portal by the agency client. Another significant difference is that the marketing agency and/or the agency client can add content revisions to the written content during the revision process. The content revisions of both the agency client and the marketing agency are stored with the written content in the projects database, and the remainder of the revision process is the same as the revision process with the single client.

The present invention also allows for other notable features on the agency account that are not available on the single client account. One notable feature is that the agency account is able to manage an unlimited number of clients and their projects all from one dashboard screen. Another notable feature is that the present invention allows the marketing agency to create new email templates and to customize the agency account to send emails from the agency's own domain to their clients. The agency account also allows the marketing agency to view a complete history of all email notifications sent by the present invention to the agency's clients. The last notable feature is that the present invention produces detailed reports for the marketing agency showing the breakdown of activity by both the agency's writers and the agency's clients.

Although the invention has been explained in relation to its preferred embodiment, it is to be understood that many other possible modifications and variations can be made without departing from the spirit and scope of the invention as hereinafter claimed.

What is claimed is:

1. A method of developing search engine optimized content by executing computer-executable instructions stored on a non-transitory computer-readable medium, the method comprises the steps of:
providing a single client account and an agency account, wherein said single client account and said agency account each includes a monetary fund, a list of favorite writers, a list of in-house writers, and a list of blocked writers;
providing said agency account, wherein said agency account also includes a list of agency clients;
providing a writer account, wherein said writer account includes a list of requested jobs;
providing a jobs database, wherein said jobs database comprises a list of unfinished projects;
providing a writer database, wherein said writer database comprises a list of available writers;
providing a projects database;
generating a private labeled portal for said agency account, wherein said private labeled portal includes branding data, agency client access data, user access data, and contact data;
generating an agency client account for said agency account, wherein said agency client account includes agency client personal data and agency client contact data;
generating a project profile for either said single client account or said agency client account, wherein said project profile includes project preliminary data, project description data, project topic data, project title data, search engine optimization (SEO) settings data, and writer assignment data;
generating said project profile for said agency client account, wherein said project profile for said agency client account also includes an agency client questionnaire data;
generating a writer profile for said writer account, wherein said writer profile includes a pen name, a sample content, a quality rating, a description of background knowledge, a rejection rate, a written content history data, and a compensation rate;
assigning said project profile to said writer account;
retrieving a written content through said writer account;
adding said written content to said projects database;
analyzing said written content to ensure said written content is unique and has not been plagiarized;
sending a content review notice through either said single client account or said agency account and said agency client account;
accessing said projects database to retrieve and display said written content on a content revision screen; and
prompting to choose between accepting said written content, rejecting said written content, or entering a revision process for said written content.

2. The method of developing search engine optimized content by executing computer-executable instructions stored on a non-transitory computer-readable medium, the method as claimed in claim 1 comprises,
prompting for said branding data, said agency client access data, said user access data, said user access data, and said agency contact data through said agency account.

3. The method of developing search engine optimized content by executing computer-executable instructions stored on a non-transitory computer-readable medium, the method as claimed in claim 1 comprises,
prompting for said agency client personal data and said agency client contact data through said agency account; and
adding said agency client account to said list of agency clients.

4. The method of developing search engine optimized content by executing computer-executable instructions stored on a non-transitory computer-readable medium, the method as claimed in claim 1 comprises,
prompting for said project preliminary data, wherein said project preliminary data includes a project name and a content type;
prompting for agency client questionnaire data only if project profile is generated for agency client account;
prompting for said project description data, wherein said project description data includes a word count range, a writing style, a narrative, additional options, and additional writing instructions;
prompting for said project topic data, wherein said project topic data includes a plurality of keywords;
prompting for a keyword priority rank for each of said plurality of keywords;
prompting for said project title data, where said project title data includes a plurality of titles;
prompting for a title priority rank for each of said plurality of titles;
prompting for said SEO settings data, wherein said SEO settings data includes a keyword density; and
prompting to choose between four different options to assign said project profile to said writer account.

5. The method of developing search engine optimized content by executing computer-executable instructions stored on a non-transitory computer-readable medium, the method as claimed in claim 4 comprises,
prompting for said optimized posting data, wherein optimized posting data includes a maximum price offer;
running an optimized posting process for said writer profiles with highest quality rating, until said project profile is assigned to said writer account; and
reiterating said optimized posting process for said writer profile with lower quality rating, until said project profile is assigned to said writer account.

6. The method of developing search engine optimized content by executing computer-executable instructions stored on a non-transitory computer-readable medium, the method as claimed in claim 5 comprises,
adding said project profile to said jobs database with lowest price offer; and
increasing said price offer for said project profile after a set amount of time, while said price offer is less than or equal to said maximum price offer.

7. The method of developing search engine optimized content by executing computer-executable instructions stored on a non-transitory computer-readable medium, the method as claimed in claim 4 comprises,
prompting for said writer assignment data, wherein said writer assignment data includes a required background knowledge, a minimum quality rating, a maximum rejection rate, and a maximum compensation rate; and
adding said project profile to said jobs database.

8. The method of developing search engine optimized content by executing computer-executable instructions stored on a non-transitory computer-readable medium, the method as claimed in claim 4 comprises,
retrieving and displaying said list of favorite writers from either said single client account or said agency account;
prompting to choose from said list of favorite writers; and
adding said project profile to said list of requested jobs on said writer account.

9. The method of developing search engine optimized content by executing computer-executable instructions stored on a non-transitory computer-readable medium, the method as claimed in claim 4 comprises,
retrieving and displaying said list of in-house writers from either said single client account or said agency account;
prompting to choose from said list of in-house writers; and
adding said project profile to said list of requested jobs.

10. The method of developing search engine optimized content by executing computer-executable instructions stored on a non-transitory computer-readable medium, the method as claimed in claim 1 comprises,
prompting for said pen name;
prompting for said description of background knowledge;
prompting for said compensation rate;
prompting for said sample content;
assigning said initial quality rating to said writer profile based on said sample content; and
adding said writer profile to said writer database.

11. The method of developing search engine optimized content by executing computer-executable instructions stored on a non-transitory computer-readable medium, the method as claimed in claim 10 comprises,
accessing said jobs database to cater said list of unfinished projects for said writer profile; and
displaying said list of unfinished projects and prompting to choose said project profile from said list of unfinished projects.

12. The method of developing search engine optimized content by executing computer-executable instructions stored on a non-transitory computer-readable medium, the method as claimed in claim 10 comprises,
displaying said list of requested jobs and prompting to choose said project profile from said list of requested jobs.

13. The method of developing search engine optimized content by executing computer-executable instructions stored on a non-transitory computer-readable medium, the method as claimed in claim 1 comprises,
displaying a content entry screen;
retrieving a written content from said content entry screen; and
checking said written content for said keyword density.

14. The method of developing search engine optimized content by executing computer-executable instructions stored on a non-transitory computer-readable medium, the method as claimed in claim 1 comprises,
searching an internet database to find other written content similar to said written content.

15. The method of developing search engine optimized content by executing computer-executable instructions stored on a non-transitory computer-readable medium, the method as claimed in claim 1 comprises,
prompting to enter content revisions, wherein said content revisions include edits to text and notes to writer;
storing said content revisions with said written content in said projects database;
sending a corrections notice through said writer account;
accessing said projects database to retrieve and display said written content with said content revisions on said content revision screen;
prompting to enter writer corrections, wherein said writer corrections include reedits to text and notes to client;
storing said writer corrections with said written content in said projects database;
sending a content acceptance notice through either said single client account or said agency account and said agency client account;
accessing said projects database to retrieve and display said written content with said writer corrections on said content revision screen; and
prompting to choose between accepting said written content with writer corrections, declining said written content with said writer corrections, or repeating said revision process for said written content with said writer corrections.

16. The method of developing search engine optimized content by executing computer-executable instructions stored on a non-transitory computer-readable medium, the method as claimed in claim 1 comprises,
transferring monetary funds from either said single client account or said agency account to said writer account;
accessing said writer database to update said quality rating, said written content history, and said rejection rate of said writer profile;
prompting to add said writer profile to said list of favorite writers on said single client account or on said agency account; and
outputting said written content as a formatted file or publishing said written content on an online media.

17. The method of developing search engine optimized content by executing computer-executable instructions stored on a non-transitory computer-readable medium, the method as claimed in claim 1 comprises,
prompting to add said writer profile to said list of blocked writers on said single client account or on said agency account; and
accessing said writer database to update said rejection rate of said writer profile.
